(19) United States
(12) Patent Application Publication
(10) Pub. No.: US 2016/0282026 A1
(43) Pub. Date: Sep. 29, 2016

(54) AIR CONDITIONER AMD METHOD OF CONTROLLING AN AIR CONDITIONER

(71) Applicant: LG ELECTRONICS INC., Seoul (KR)

(72) Inventor: Sangjun PARK, Seoul (KR)

(21) Appl. No.: 15/079,750

(22) Filed: Mar. 24, 2016

(30) Foreign Application Priority Data
Mar. 24, 2015 (KR) 10-2015-0040989

(51) Int. Cl. F25B 49/02; G05B 15/02

(52) U.S. Cl. CPC F25B 49/022; G05B 15/02; F25B 2600/0253; F25B 2700/00; F25B 2500/13

(57) ABSTRACT

An air conditioner and a method of controlling an air conditioner are provided. The air conditioner may sense vibration of a compressor during operation of the air conditioner, assess a level of an amplitude of the vibration, perform emergency control of the compressor, and register an avoid frequency through analysis of components of the vibration, so as to control an operating frequency of the compressor and ensure that no resonance may occur.

### CROSS-REFERENCE TO RELATED APPLICATION

This application claims priority under 35 U.S.C. §119 to Korean Application No. 10-2015-0040989 filed on Mar. 24, 2015, whose entire disclosure is incorporated herein by reference.

### BACKGROUND

1. Field

An air conditioner and a method of controlling an air conditioner are disclosed herein.

2. Background

Air conditioners may provide a comfortable indoor environment by blowing cold or warm air to regulate indoor temperature and purify indoor air. An air conditioner may include an indoor device, which may include a heat exchanger and may be installed in a room, and an outdoor device, which may include a compressor and a heat exchanger and may supply refrigerant to the indoor device. The indoor device and the outdoor device may be separately controlled, and the air conditioner may operate by controlling a power supply supplied to the compressor or to the heat exchanger.

At least one indoor device may be connected to the outdoor device, and a refrigerant may be supplied to the at least one indoor device in a cooling mode or a heating mode. In the cooling mode, when a high-pressure, high-temperature liquid refrigerant is supplied to the indoor device via the heat exchanger and the compressor of the outdoor device, the refrigerant expands into a gas in the heat exchanger of the indoor device, cooling a surrounding temperature of air, and an indoor fan may rotate to blow the cooled air into the room. In the heating mode, when a high-temperature, high-pressure gaseous refrigerant is supplied to the indoor device from the compressor of the outdoor device, the refrigerant turns into a liquid in the heat exchanger of the indoor device, and air may be warmed by energy released from the refrigerant and blown into the room by the indoor fan.

As an operating condition of the compressor may be a major control factor for the air conditioner, controlling the air conditioner to detect a malfunction in the compressor or monitor the operating condition of the compressor may be needed. The compressor may operate at varying operating frequencies depending on an amount of load. When the compressor operates at a particular operating frequency, it may produce vibration and, in some cases, resonance. Vibration may affect an operation of the compressor depending on an age or condition of the compressor and may cause damage to the compressor, for example, when the air conditioner is operated for a long period of time.

A refrigerant inlet pipe and a refrigerant outlet pipe may be connected to the compressor, and vibration caused when the compressor operates at a particular operating frequency may be transmitted to the compressor and to the pipes connected to the compressor. This may cause a malfunction in the pipes. By detecting a frequency at which vibration occurs, the malfunction may be prevented.

### BRIEF DESCRIPTION OF THE DRAWINGS

Embodiments will be described in detail with reference to the following drawings in which like reference numerals refer to like elements, and wherein:

FIG. 1 is a schematic diagram of an air conditioner according to an embodiment;

FIG. 2 is a schematic diagram of control components of the air conditioner according to an embodiment;

FIG. 3 is a view of a compressor of the air conditioner according to an embodiment;

FIGS. 4A-4B are views of a vibration sensor in a pipe of the air conditioner according to an embodiment;

FIG. 5 is a view showing displacement of the pipe and the vibration sensor in the air conditioner according to an embodiment;

FIG. 6 is a view of a vibration detecting circuit of the air conditioner according to an embodiment;

FIG. 7 is a graph showing displacement of a pipe caused by vibration of the compressor and resulting changes in electrical capacitance in the air conditioner according to an embodiment;

FIG. 8 is a flowchart of a method of detecting vibrational components of a compressor of an air conditioner according to an embodiment;

FIG. 9 is a flowchart of a method of controlling an air conditioner based on vibration amplitude according to an embodiment;

FIG. 10 is a flowchart of a method of resetting avoid frequencies to control a compressor based on vibration amplitude in an air conditioner according to an embodiment;

FIG. 11A is a graph showing changes in frequency with temperature in an air conditioner according to an embodiment;

FIG. 11B is a table showing the changes in frequency with temperature in the air conditioner as graphed in FIG. 11A; and

FIG. 12 is a flowchart of a method of updating avoid frequencies based on vibration amplitude in an air conditioner according to an embodiment.

### DETAILED DESCRIPTION

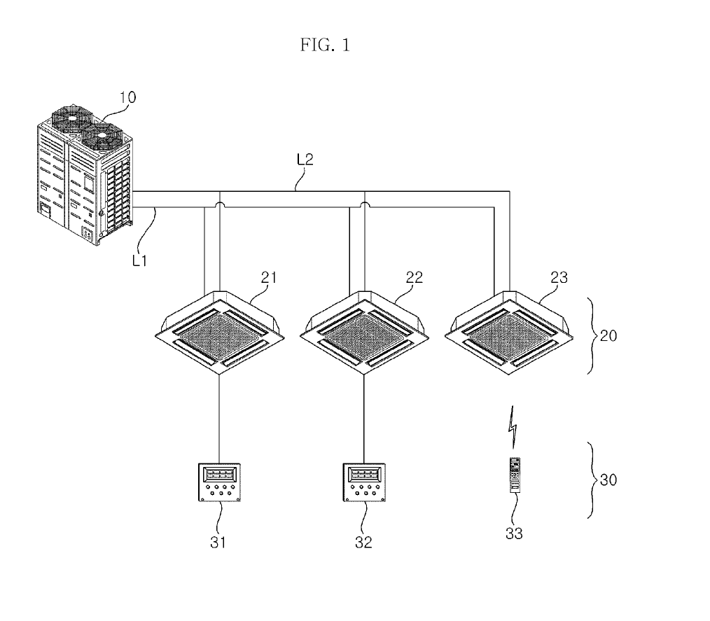

FIG. 1 is a schematic diagram of an air conditioner according to an embodiment. Referring to FIG. 1, the air conditioner may include a plurality of indoor devices 20, for example, indoor devices 21 to 23, at least one outdoor device 10, and a plurality of remote controllers 30, for example, remote controllers 31 to 33, in communication with the plurality of indoor devices 20. The plurality of remote controllers may be in communication with the plurality of indoor devices 20 and the outdoor device 10 and monitor and control their operation.

The air conditioner may be categorized as, for example, a ceiling-mounted, floor-standing, or wall-mounted air conditioner, depending on its installation position. The air conditioner may further include other units or devices, such as, for example, a ventilation device, an air freshener, a humidifier, dehumidifier, and/or a heater, in addition to the outdoor device 10 and the indoor devices 20, but description thereof has been omitted and embodiment are not limited thereto.

The plurality of indoor devices 20 may each include an expansion valve that expands the refrigerant supplied from the outdoor device 10 by a refrigerant pipe L1, an indoor heat exchanger (not shown) that exchanges heat with the refrigerant, an indoor device fan (not shown) that allows indoor air into the indoor heat exchanger and exposes heat-exchanged air to the room, a plurality of sensors (not shown), and a controller (not shown) that controls an operation of the respective indoor device of the plurality of indoor devices 20. Each of the plurality of indoor devices 20 may further include an exhaust opening (not shown) that discharges the heat-exchanged air, and the exhaust opening may be provided with an air direction controller to open or close the exhaust opening and control a direction of exhausted or discharged air. The indoor device may control intake air and exhausted air by controlling a rotation speed of the indoor device fan, and also control an amount of air taken in or exhausted. Each of the plurality of indoor devices 20 may further include a human body sensor (not shown) that detects a human presence in an indoor space, an output (not shown) that displays operating conditions and settings of the respective indoor device, and an input (not shown) to input settings data.

The outdoor device 10 may operate in a cooling mode or a heating mode in response to a request from the plurality of indoor devices 20 received via a communication line L2, or a control command from the plurality of remote controllers 30 and may supply refrigerant to the indoor devices 21 to 23. The outdoor device 10 may include at least one compressor 130 that compresses incoming refrigerant and discharges high-pressure gaseous refrigerant, an accumulator (not shown) that separates gaseous refrigerant and liquid refrigerant from each other to prevent unevaporated liquid refrigerant from entering the compressor 130, an oil separator (not shown) that recovers oil from the refrigerant discharged from the compressor, an outdoor heat exchanger (not shown) that condenses or evaporates refrigerant via heat exchange with outside air, an outdoor device fan (not shown) that draws air into the outdoor heat exchanger and blows out the heat-exchanged air in order to facilitate the heat exchange by the outdoor heat exchanger, a four-way valve (not shown) that changes a flow passage of the refrigerant depending on an operation mode of the outdoor device 10, at least one pressure sensor that measures pressure, at least one temperature sensor 160 that measures temperature, and control components that control the operation of the outdoor device 10 and communicates with other devices or components. The outdoor device 10 may further include, for example, a plurality of sensors, a valve, a supercooling device, but description thereof has been omitted and embodiments are not limited thereto.

The plurality of remote controllers 30 may be connected to the plurality of indoor devices 20 with wires or wirelessly to send or receive data, may allow a user to input operational settings, such as, for example, operation mode, temperature, amount of air, and operation schedules, and may transmit the settings to the plurality of indoor devices 20 so that the plurality of indoor devices 20 may run according to the settings. The plurality of remote controllers 30 may receive data from the plurality of indoor devices 20, display the operating condition of the plurality of indoor devices 20, and transmit the data to the plurality of indoor devices 20 so that the plurality of indoor devices 20 may run according to predetermined settings.

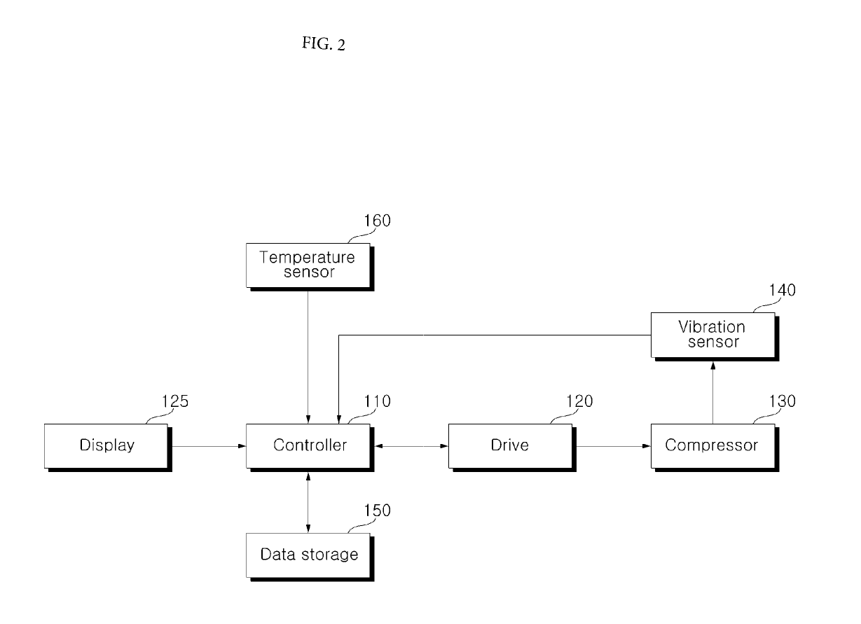

FIG. 2 is a schematic diagram of control components of the air conditioner according to an embodiment. Referring to FIG. 2, the outdoor device 10 may include a data storage 150, a drive 120, the compressor 130, a vibration sensor 140, a temperature sensor 160, and a controller 110 that controls overall operation. Description of other components of the outdoor device 10 previously described has been omitted.

The outdoor device 10 may further include an input (not shown) including a predetermined input, such as, for example, at least one button or switch. As the input device is operated, the input may send commands, such as, for example, power input, address setting, test operation, to the controller 110. The outdoor device 10 may further include an output including a display 125 that displays information on the air conditioner's operation settings, operating conditions, and malfunctions, a buzzer or speaker that produces a predetermined sound effect or warning sound, and a lamp that glows or blinks to indicate a connection status to each device or to issue a warning. The output may issue a warning about a malfunction in the compressor in response to a control command from the controller 110, in at least one of the following exemplary forms: a warning message, a warning light, and a warning sound.

The outdoor device 10 may further include a communication device including a plurality of wired or wireless communication modules. The communication device may send or receive data to or from a connected indoor device 20 in response to a control command from the controller 110 to receive data about operation settings from the indoor device. The communication device may transmit an indication signal about a malfunction in the outdoor device 10 so that the indoor device may issue a warning.

The drive 120 may control the operation of the compressor 130 in response to a control command from the controller 110. The drive 120 may supply operating power to the compressor 130 to run the compressor 130 and may allow the compressor 130 to run at a predetermined operating frequency in response to a control command from the controller 110. The drive 120 may be provided with an outdoor device fan drive or valve controller in order to control the operation of the outdoor device fan or valve, as well as the operation of the compressor 130.

The data storage 150 may store control data for outdoor device operation, frequency data for control of the compressor 130, data detected during the outdoor device operation, and data input or output through the communication device. The data storage 150 may store address data to send or receive data to or from the plurality of indoor devices 20 or external devices.

The outdoor device 10 may be provided with a plurality of sensors installed inside or outside of the outdoor device 10. The plurality of sensors may detect and measure data about the outdoor device 10 and its operating condition and may send the data to the controller 110. For example, the plurality of sensors may include sensors that measure temperature, pressure, humidity, carbon dioxide, airflow, voltage, and current inside and outside of the outdoor device 10, for example.

The temperature sensor 160 may include a plurality of temperature sensors and may be installed inside or outside of the outdoor device 10 to measure temperatures inside and outside of the outdoor device 10. The temperature sensor 160 may be installed at an intake port, through which external air is drawn in, or at an outside of the outdoor device fan to measure outdoor temperature. The temperature sensor 160 may be installed in a refrigerant pipe to measure intake and discharge temperatures and report the temperatures to the controller 110.

The vibration sensor 140 may sense vibration of the compressor 130. The vibration sensor 140 may be installed in the compressor 130 or in a pipe connected to the compressor 130 to sense vibration caused by operation of the compressor 130. The vibration sensor 140 may detect an amplitude and frequency of vibration and report the amplitude and frequency to the controller 110.

The controller 110 may control the air conditioner to perform a given operation based on operating settings or a request from the plurality of indoor devices 20 and may control the operation of the outdoor device 10 to determine if the outdoor device 10 is operating normally based on data input from different sensors. Also, the controller 110 may process input or output data and control data transmission and reception through the communication device.

The controller 110 may apply a control command to the drive 120 so that the compressor 130 may run based on operation settings received from the plurality of indoor devices 20. Thus, the controller 110 may control an operating frequency of the compressor 130. The controller 110 may register the operating frequency of the compressor 130 according to a vibration sensed by the vibration sensor 140 as an avoid frequency and may store the avoid frequency in the data storage 150. When the vibration sensor 140 senses a vibration, the controller 110 may register the operating frequency of the compressor 130 at which the vibration occurs as the avoid frequency based on a vibration amplitude. For example, the controller 110 may detect a resonant frequency at which resonance occurs by analyzing the vibration sensed by the vibration sensor 140 based on input data. The controller 110 may analyze the amplitude and frequency of the vibration input from the vibration sensor 140 to determine the resonant frequency of the compressor 130 based on the frequency at which the vibration occurs. The controller 110 may register the operating frequency of the compressor 130 at which resonance occurs as an avoid frequency.

The controller 110 may control the compressor 130 to run at operating frequencies other than a registered avoid frequency. Accordingly, the outdoor device 10 may be controlled such that vibration, for example, resonance, may not occur due to the operation of the compressor 130. The controller 110 may manage the avoid frequency by adding or deleting the avoid frequency based on data from the vibration sensor 140 or from the temperature sensor 160.

The controller 110 may assess a level of amplitude of the vibration sensed by the vibration sensor 140 and may manage the avoid frequency according to the level of amplitude of the vibration. The controller 110 may reset existing avoid frequencies based on temperature changes as the resonant frequency varies with temperature. For high-amplitude vibrations, the controller 110 may perform emergency control of the compressor 130 if the amplitude is a certain level or higher, and if necessary, may stop the operation of the compressor 130. During emergency control, the controller 110 may transmit an emergency control warning or indication signal to the plurality of indoor devices 20.

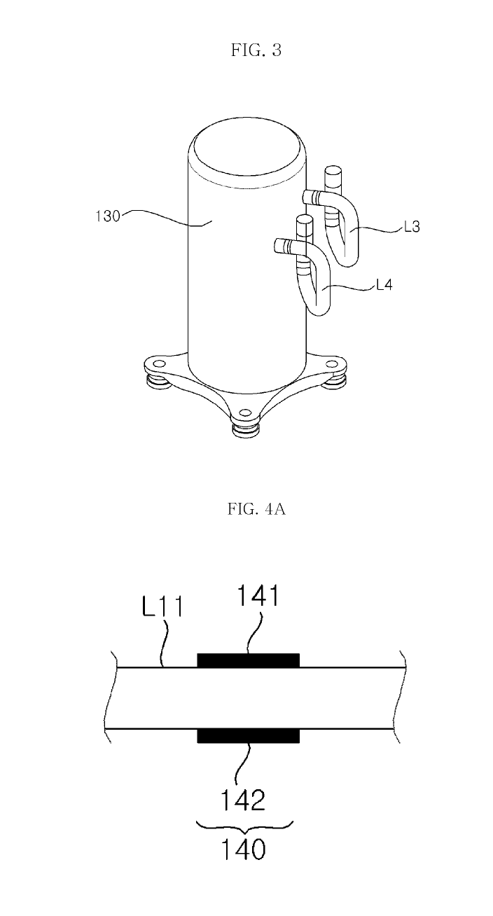

FIG. 3 is a view of a compressor of the air conditioner according to an embodiment. As illustrated in FIG. 3, the outdoor device 10 may be provided with a compressor 130. The outdoor device 10 may be provided with one or more compressors depending on an amount of load. The compressor 130 may be categorized by type as a constant-speed compressor or an inverter compressor. The constant-speed compressor may be turned on or off and may run at a specified operating frequency, and the inverter compressor may run at varying operating frequencies. An embodiment in which the compressor 130 is an inverter compressor is described hereinafter.

Refrigerant pipes L3 and L4 may be connected to the compressor 130. That is, an intake pipe that draws refrigerant into the compressor 130 and a discharge pipe that discharges refrigerant from the compressor 130 may be connected to the compressor 130. Also, an oil recovery unit or oil separator and an accumulator (not shown) may be connected to the compressor 130. Accordingly, when a low-temperature, low-pressure gaseous refrigerant enters the compressor 130, the compressor 130 may compress the refrigerant and discharge a high-temperature, high-pressure refrigerant.

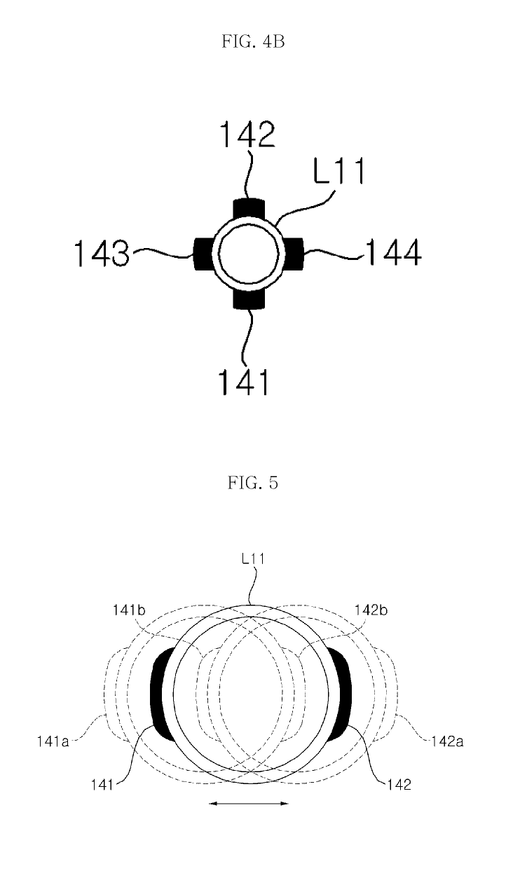

FIGS. 4A-4B are views of a vibration sensor in a pipe of the air conditioner according to an embodiment. As illustrated in FIGS. 4A-4B, the vibration sensor 140 may be provided at or on a refrigerant pipe L11 connected to the compressor 130.

As illustrated in FIG. 4A, the vibration sensor 140 may be in close contact with a surface of the refrigerant pipe L11 and may be provided in a way so that two sensors, for example, a first sensor 141 and a second sensor 142, face each other. That is, the first sensor 141 and the second sensor 142 may be approximately 180 degrees from each other with respect to a cross-section of the refrigerant pipe L11. The first sensor 141 and the second sensor 142 may be used as electrodes to sense vibration.

Assuming a reference line extending between the first sensor 141 and the second sensor 142, the vibration sensor 140 may detect the amplitude of vibration that occurs horizontally with respect to the reference line. Also, the vibration sensor 140 may sense a vibration at a predetermined angle from locations of the first sensor 141 and the second sensor 142.

As illustrated in FIG. 4B, the vibration sensor 140 may have first to fourth sensors 141 to 144 provided at or on the refrigerant pipe L11. The first to fourth sensors 141 to 144 may be used as electrodes to sense vibration. The first to fourth sensors 141 to 144 may be spaced approximately 90 degrees from each other with respect to a cross-section of the refrigerant pipe L11. Accordingly, the vibration sensor 140 may sense vibrations in various directions caused by the operation of the compressor 130.

FIG. 5 is a view showing displacement the pipe and the vibration sensor in the air conditioner according to an embodiment. As illustrated in FIG. 5, when the compressor 130 runs at a particular operating frequency, a vibration may occur. The vibration may be transmitted to the refrigerant pipe L11 connected to the compressor 130. Accordingly, the refrigerant pipe L11 may vibrate with a certain amplitude, and the vibration sensor 140 provided at or on the refrigerant pipe L11 may detect the amplitude and frequency of the vibration. If the refrigerant pipe L11 vibrates, for example, horizontally to the left and right, positions of the first and second sensors 141 and 142 may change. For example, first sensor 141 may be displaced to a first position 141a or to a second position 141b, and second sensor 142 may be displaced to a first position 142b or to a second position 142a when the refrigerant pipe L11 vibrates. The first and second sensors 141 and 142 may detect the amplitude and frequency of the vibration based on a displacement and a displacement rate.

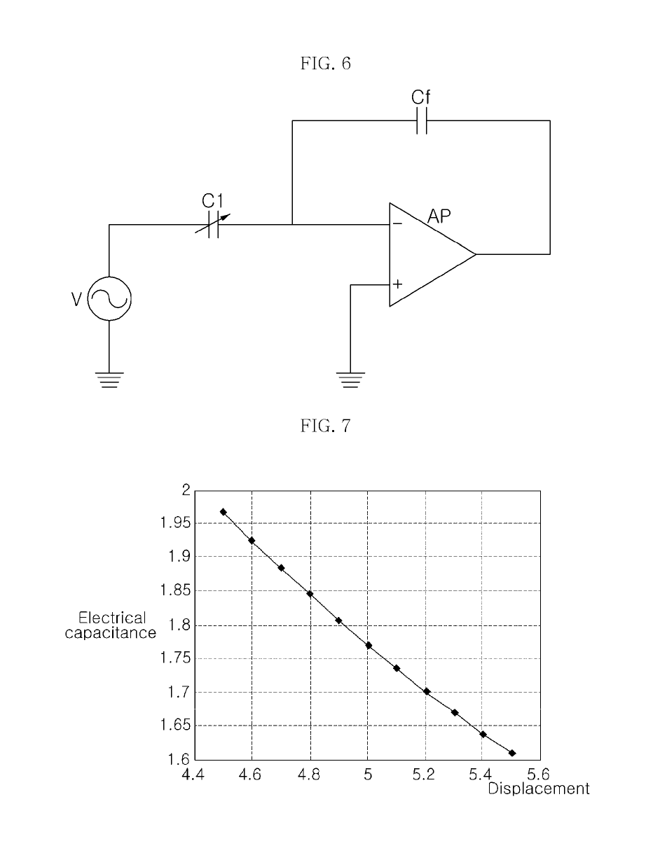

FIG. 6 is a view of a vibration detecting circuit of the air conditioner according to an embodiment. As illustrated in FIG. 6, the vibration sensor 140 may include a vibration detecting circuit, to which the first and second sensors 141 and 142 acting as electrodes may be connected. The vibration detecting circuit may be a low-input impedance amplifier, which may be used in microelectromechanical systems (MEMS) and may estimate electrical capacitance between two electrodes, for example, the first and second sensors 141 and 142, displaced due to vibration of the compressor 130. The vibration detecting circuit may include a feedback capacitor Cf, and a capacitor C1, which may represent a capacitance formed depending on an inter-electrode distance between the first and second sensors 141 and 142.

If the compressor 130 vibrates in a first direction, for example, on an X-axis, the refrigerant pipe L11 may also vibrate in the first direction. The distance between the first and second sensors 141 and 142 may change due to fast vibration, and the electrical capacitance of the capacitor C1 in the vibration detecting circuit may vary. When a voltage V is supplied, the electrical capacitance of the capacitor C1 with the first and second sensors 141 and 142 used as electrodes may vary due to vibration. Then, the vibration may be amplified by an amplifier AP to be detected.

FIG. 7 is a graph showing displacement of a pipe caused by vibration of the compressor and resulting changes in electrical capacitance in the air conditioner according to an embodiment. By measuring changes in electrical capacitance caused by the displacement of the first and second sensors 141 and 142, a resulting vibration of the compressor 130 may be predicted. FIG. 7 is a graph showing results of predictions about vibration of the compressor 130 based on measurement data.

As illustrated in the graph of FIG. 7, an electrical capacitance of the vibration detecting circuit may vary with the displacement of the first and second sensors 141 and 142 of the vibration sensor 140. The vibration may be sensed in units as small as approximately 5 μm, which may allow for precise measurement of vibration of the compressor 130. The controller 110 may register the operating frequencies according to the frequency of vibration of the compressor 130 as an avoid frequency, based on vibration amplitude and frequency data input from the vibration sensor 140.

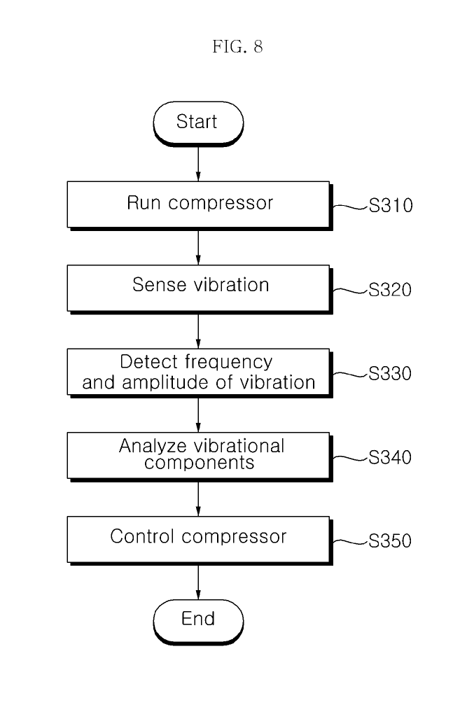

FIG. 8 is a flowchart of a method of detecting vibrational components of a compressor of an air conditioner according to an embodiment. As illustrated in FIG. 8, when an air conditioner starts running according to operation settings, a compressor, such as compressor 130 discussed above, may run on power supplied from a drive, such as drive 120 discussed above (S310). The operating frequency of the compressor may be controlled by a controller, such as controller 110 discussed above.

A vibration sensor, such as vibration sensor 140 discussed above, may be provided at or on a refrigerant pipe and may sense vibration of the compressor. The vibration may be sensed due to the displacement of first and second sensors, such as first and second sensors 141 and 142 discussed above, provided as electrodes at the refrigerant pipe. The vibration sensor may detect the amplitude and frequency of the vibration sensed (S330).

The controller may analyze components of the vibration based on vibration amplitude and frequency data input from the vibration sensor (S340). Accordingly, when a certain level of vibration or higher occurs, the controller may check the operating frequency at which the vibration has occurred in the compressor, and may register the operating frequency as an avoid frequency. The controller may also control the compressor to run at operating frequencies other than the avoid frequency (S350). The controller may store data on the resonant frequency of the compressor determined through analysis of the vibration and may register the corresponding operating frequency as an avoid frequency that prevents resonance.

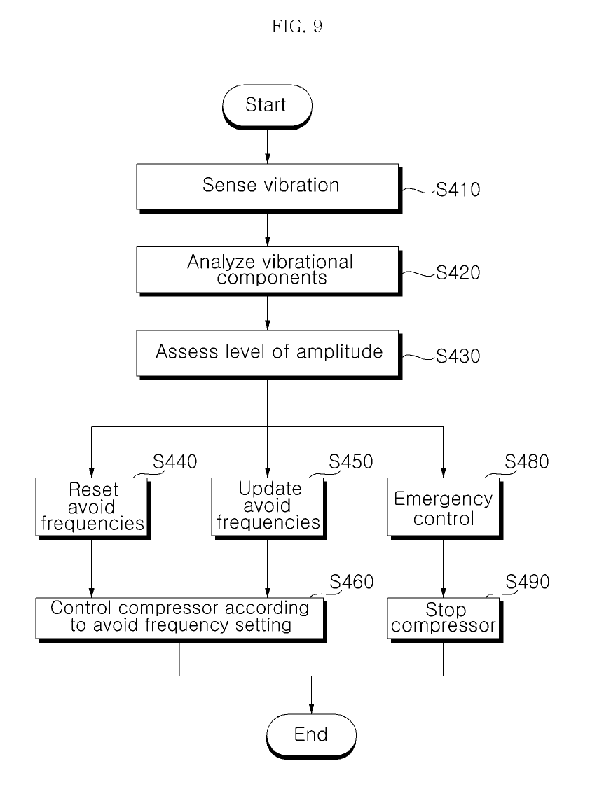

FIG. 9 is a view of a method of controlling an air conditioner based on vibration amplitude according to an embodiment. As illustrated in FIG. 9, the air conditioner may start running according to operation settings. A controller, such as controller 110 discussed above, of an outdoor device, such as outdoor device 10 discussed above, may control a compressor, such as compressor 130 discussed above, according to the operation settings. When a vibration occurs due to the compressor operating at a particular operating frequency, a vibration sensor, such as vibration sensor 140 discussed above, may sense the vibration of the compressor.

The vibration sensor may send vibration amplitude and frequency data to the controller, and the controller may analyze the vibration based on the data input from the vibration sensor (S420). Accordingly, the controller may detect an avoid frequency.

The controller may assess a level of amplitude of the vibration sensed (S430). The amplitude may be classified into a first predetermined level, Level 1, which may represent a small amplitude, a second predetermined level, Level 2, which may represent a large amplitude, and a third predetermined level, Level 3, which may represent an abnormal operation, according to how large the amplitude may be. While the controller classifies amplitude into three levels, a reference level for amplitude assessment and a number of levels may vary with settings. For example, the first predetermined level may be an amplitude of about 2 to 3 mm, the second predetermined level may be an amplitude of 3 to 5 mm, and the third predetermined level may be an amplitude of 5 mm or greater.

If the amplitude is within Level 1, the controller may reset stored existing avoid frequencies (S440). The existing avoid frequencies may be reset according to an avoid frequency resetting method described hereinafter. The controller may control the compressor according to the avoid frequency setting (S460). If the amplitude is within Level 2, the controller may update the avoid frequencies (S450). Based on updated avoid frequencies, the controller may control the compressor to run at operating frequencies other than the avoid frequencies (S460).

If the amplitude is at or greater than Level 3, the controller may perform emergency control because the vibration may be stronger than the reference level (S480). Under emergency control, the controller may register the operating frequency that corresponds to the vibration sensed as an avoid frequency. The controller may stop the compressor while performing emergency control (S490), and may temporarily stop an existing operation. The controller may issue a warning about emergency stop and may stop the operation of the compressor or resume the operation after stopping for a predetermined period of time. As resonance at Level 3 has occurred, the controller may register the operating frequency as an avoid frequency before stopping the operation so that a same kind of vibration may not occur in subsequent operations.

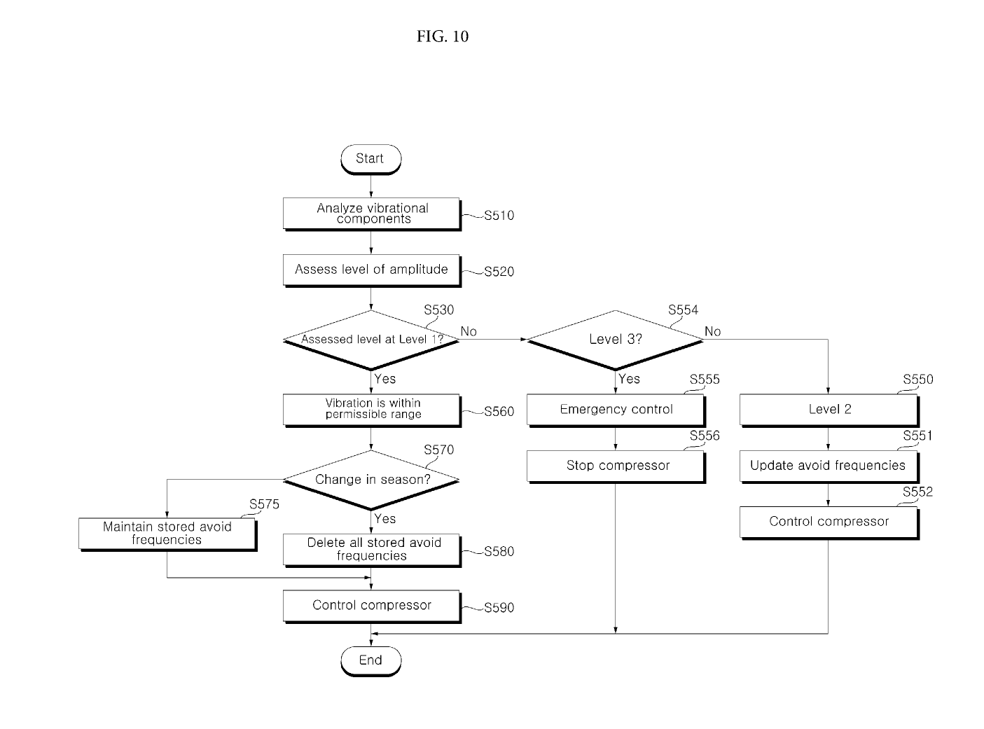

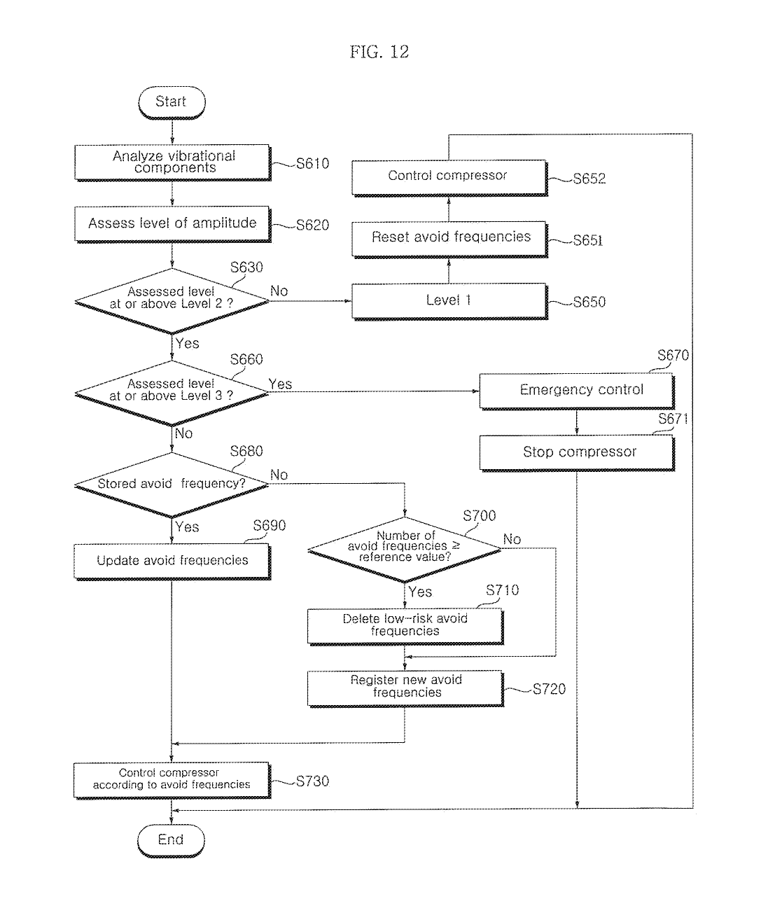

FIG. 10 is a flowchart of a method of resetting avoid frequencies to control a compressor based on vibration amplitude in an air conditioner according to an embodiment. As illustrated in FIG. 10, a controller, such as controller 110 discussed above, may analyze components of vibration based on data input from a vibration sensor, such as vibration sensor 140 discussed above (S510), and may assess a level of amplitude (S520). The assessed level may be compared with a first predetermined level, Level 1 (S530). If the assessed level is at a second predetermined level, Level 2, or a third predetermined level, Level 3, which may be higher than Level 1, the controller may update the existing avoid frequencies or may perform emergency control, as shown in FIG. 12 and discussed hereinafter. If the assessed level is at Level 1, the controller may operate as follows.

If the assessed level is at Level 1, the vibration may have an amplitude of about 2 to 3 mm, and the controller may determine that the vibration may be within a permissible range (S560). The controller may register the operating frequency when the vibration at Level 1 has occurred as an avoid frequency because the vibration has occurred, even though the vibration may be within the permissible range.

The controller may receive input of measured outdoor temperatures from a temperature sensor, such as temperature sensor 160 discussed above, and detect a change in season (S570). The controller may detect a change in season based on outdoor temperatures. For example, the controller may detect a change in season based on cumulative temperature data by any one of the following methods: measurement of average temperature over a given period of time, measurement of temperature differences, and comparison with temperature data for a previous year.

If a change in season is detected, the controller may reset all stored avoid frequencies by deleting the stored avoid frequencies from a data storage, such as data storage 150 discussed above (S580). If there is no change in season, the stored avoid frequencies may be maintained (S575). The controller may control the compressor based on the avoid frequencies (S590).

If the assessed level is within Level 2 (S550), the controller may update the avoid frequencies (S551), and control the compressor to run at operating frequencies other than the avoid frequencies (S552). If the assessed level is at or greater than Level 3 (S554), the controller may perform emergency control (S555), and may temporarily stop the compressor (S556).

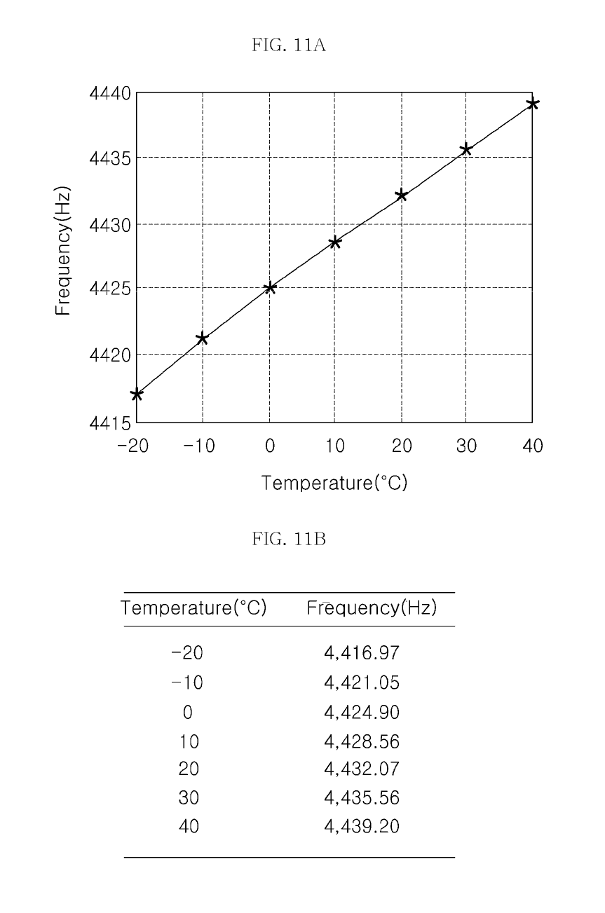

FIG. 11A is a graph showing changes in frequency with temperature in the air conditioner according to an embodiment. FIG. 11B is a table showing the changes in frequency with temperature in the air conditioner as graphed in FIG. 11A. As illustrated in FIGS. 11A-11B, when there is a temperature change, a resonant frequency of a compressor according to embodiments may change.

As illustrated in FIG. 11A, when the temperature rises above 0° C., the resonant frequency of the compressor also may increase. Frequency values for different temperatures in the graph of FIG. 11A are listed in FIG. 11B. As illustrated in FIG. 11B, the resonant frequency of the compressor was 4416.97 Hz at −20° C., 4424.90 Hz at 0° C., and as high as 4432.07 Hz at 20° C., respectively. Thus, as resonant frequency changes with seasons, the resonant frequency of vibration of the compressor may vary with seasons.

For low-amplitude vibrations, for example, Level 1 vibrations, the controller may determine that the vibration may be within a permissible range. As described above, the resonant frequency may change with seasons because a temperature change or season change may affect the resonant frequency. Thus, the controller may detect a change in season based on temperatures and may reset all existing avoid frequencies.

For example, there may be stored avoid frequencies registered for a summer season, but the air conditioner may be run during a winter season. The stored avoid frequencies registered for the summer season may not be consistent with resonance frequencies for the winter season, so the controller may reset all the stored avoid frequencies for the summer season and register new avoid frequencies for the winter season. The controller may delete all but the most recent avoid frequencies that have been registered during a predetermined period after a certain point in time.

FIG. 12 is a flowchart of a method of updating avoid frequencies based on vibration amplitude in an air conditioner according to an embodiment. As illustrated in FIG. 12, a controller, such as controller 110 discussed above, may analyze components of vibration based on data input from a vibration sensor, such as vibration sensor 140 discussed above (S610). The controller may assess a level of amplitude of the vibration sensed (S620). For example, the amplitude may be classified as a first predetermined level, Level 1, a second predetermined level, Level 2, and a third predetermined level, Level 3, according to how large the amplitude may be, and the reference amplitude level and the number of levels of amplitude may vary with settings.

The controller may determine whether or not the assessed level is at Level 2 or above (S630). If the assessed level is below Level 2, existing avoid frequencies may be reset according to Level 1, as described previously with reference to FIG. 10 (S650). That is, the controller may update the avoid frequencies (S651), and control the compressor to run at operating frequencies other than the avoid frequencies (S652).

If the assessed level is at Level 2 or above, the controller may determine whether or not the assessed level is at Level 3 or above (S660). If the assessed level is Level 3 or above, emergency control may be performed according to Level 3, as described previously with reference to FIG. 9 (S670), and may temporarily stop the compressor (S671). If the assessed level is at Level 2 (S640), the controller may operate as follows.

If the amplitude of the vibration of the compressor is at Level 2, the controller may analyze the resonant frequency of the vibration to determine whether the operating frequency corresponding to the resonant frequency may be a stored avoid frequency (S680). The controller may search for the operating frequency among the avoid frequencies stored in the data storage to determine whether the operating frequency is a stored avoid frequency.

If the operating frequency that corresponds to the vibration is a stored avoid frequency, the controller may update the stored avoid frequencies (S690). For example, if the operating frequency that corresponds to the vibration is an avoid frequency stored in the data storage but is of a different level than Level 2, the controller may update the level to Level 2. Also, the controller may set and update the frequency of occurrence of this avoid frequency.

If the operating frequency is not a stored avoid frequency, the controller may determine whether the number of stored avoid frequencies is equal to or greater than a reference value (S700). If the number of stored avoid frequencies is not less than the reference value, the controller may delete low-risk avoid frequencies among the stored avoid frequencies (S710) and may register new avoid frequencies (S720).

The controller may determine a level of risk for a multiplicity of registered avoid frequencies based on vibration amplitude, for example, the level of amplitude, and may delete low-risk avoid frequencies for low-amplitude vibrations. Also, the controller may assess low-frequency avoid frequencies as low-risk avoid frequencies. If the number of stored avoid frequencies is below the reference value, the controller may register new additional avoid frequencies (S720).

As described above, once the stored avoid frequencies are updated, or the existing avoid frequencies are deleted and new avoid frequencies are added, the controller may control the compressor based on the updated or added avoid frequencies so that the compressor may run at operating frequencies other than the avoid frequencies (S730). Accordingly, when a vibration occurs in the compressor, the resonant frequency of the compressor may be checked by analyzing the components of the vibration, and the operating frequency that corresponds to the resonant frequency may be registered as an avoid frequency to control the operation of the compressor. Thus, vibration of the compressor may be prevented, the operating efficiency of the compressor may be improved, and damage to the compressor may be prevented.

Embodiments disclosed herein provide an air conditioner that may monitor an operating condition of a compressor and diagnose malfunctioning of a compressor or fan or any malfunctioned component in the compressor or fan. Embodiments disclosed herein provide an air conditioner that may control a compressor to prevent resonance by detecting a frequency of vibration caused during operation of the compressor, and a method of controlling an air conditioner.

According to embodiments disclosed herein, an air conditioner may include an outdoor device and a plurality of indoor devices connected to the outdoor device, which may run a cooling operation or a heating operation, the air conditioner including a compressor that compresses refrigerant; a refrigerant pipe connected to the compressor; a vibration sensing part or sensor provided at or on the refrigerant pipe to sense a vibration; and a control part or controller that, when the vibration is sensed by the vibration sensing part, analyzes the vibration of the compressor based on data input from the vibration sensing part and registers an operating frequency of the vibration as an avoid frequency, and that controls the compressor to run at operating frequencies other than the avoid frequency.

According to embodiments disclosed herein, a method of controlling an air conditioner may include sensing a vibration of the compressor during operation by a vibration sensing part or sensor; analyzing the vibration based on data input from the vibration sensing part and assessing a level of an amplitude of the vibration; registering a frequency of the vibration as an avoid frequency according to the level of the amplitude; and controlling the compressor to run at operating frequencies other than the avoid frequency.

The air conditioner and the method of controlling the air conditioner may prevent damage to the compressor, may improve operating efficiency of the compressor by sensing vibration of the compressor during operation of the air conditioner, may detect a frequency of the vibration to sense a malfunction in the compressor, and may control an operating frequency of the compressor.

Although elements of embodiments disclosed herein have been described as being held together and operating as a single unit or module, embodiments are not limited thereto. Rather, in some embodiments, all elements may be selectively held together and operate as more than a single unit or module within the scope of the present disclosure.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner, comprising:
a compressor that compresses refrigerant;
at least one refrigerant pipe connected to the compressor;
a vibration sensor provided at the at least one refrigerant pipe to sense a vibration of the compressor; and
a controller that analyzes the vibration based on data input from the vibration sensor when the vibration is sensed and registers an operating frequency that corresponds to the vibration as an avoid frequency so as to control the compressor to run at operating frequencies other than the avoid frequency.

2. The air conditioner of claim 1, wherein the vibration sensor includes a plurality of sensors provided at the at least one refrigerant pipe and senses vibration based on displacement of the plurality of sensors.

3. The air conditioner of claim 2, wherein the plurality of sensors includes first and second sensors provided approximately 180 degrees from each other with respect to the refrigerant pipe.

4. The air conditioner of claim 3, wherein the plurality of sensors further includes third and fourth sensors provided approximately 180 degrees from each other with respect to the refrigerant pipe and approximately 90 degrees from the first and second sensors.

5. The air conditioner of claim 1, wherein the vibration sensor includes a plurality of electrodes provided at the refrigerant pipe, and the plurality of electrodes act as a capacitor along the refrigerant pipe.

6. The air conditioner of claim 1, wherein the controller analyzes an amplitude and frequency of the vibration to determine a resonant frequency of the compressor based on the frequency of the vibration.

7. The air conditioner of claim 1, wherein the controller assesses a level of an amplitude of the vibration sensed by the vibration sensor and manages the avoid frequency according to the level of the amplitude.

8. The air conditioner of claim 7, wherein, if the amplitude is at a first predetermined level, the controller resets existing avoid frequencies for the vibration, if the amplitude is at a second predetermined level, the controller adds new avoid frequencies for the vibration, and if the amplitude is at a third predetermined level, the controller registers the operating frequency that corresponds to the vibration as the avoid frequency and performs emergency control by stopping the compressor.

9. The air conditioner of claim 8, wherein the first predetermined level is an amplitude of approximately 2 to 3 mm, the second predetermined level is an amplitude of approximately 3 to 5 mm, and the third predetermined level is an amplitude of approximately 5 mm or greater.

10. The air conditioner of claim 1, wherein, if a number of stored avoid frequencies is not less than a reference value, the controller deletes low-risk avoid frequencies and registers new avoid frequencies.

11. The air conditioner of claim 1, further including a temperature sensor that measures outdoor temperatures, wherein the controller detects a change in season based on the outdoor temperatures measured by the temperature sensor, and resets existing avoid frequencies by deleting the existing avoid frequencies if the change in season is detected, and maintains the existing avoid frequencies if the change in season is not detected.

12. The air conditioner of claim 1, further including a display that displays a warning about an existing malfunction and a warning for abnormal operation in response to a control command from the controller.

13. The air conditioner of claim 1, wherein the compressor and the at least one refrigerant pipe are included in an outdoor device, and the air conditioner further includes at least one indoor device connected to the outdoor device.

14. A method of controlling an air conditioner, the method comprising:
sensing by a vibration sensor a vibration of a compressor during operation of the air conditioner;
analyzing the vibration based on data input from the vibration sensor and assessing a level of an amplitude of the vibration;
registering an operating frequency that corresponds to the vibration as an avoid frequency according to the level of the amplitude; and
controlling the compressor to run at operating frequencies other than the avoid frequency.

15. The method of claim 14, wherein, when the vibration is sensed by the vibration sensor, the operating frequency at which the vibration has occurred in the compressor is registered as the avoid frequency.

16. The method of claim 14, further including performing emergency control by stopping the compressor if the amplitude of the vibration is at a predetermined level or above.

17. The method of claim 14, further including:
resetting existing avoid frequencies for the vibration if the amplitude is at a first predetermined level;
adding new avoid frequencies for the vibration if the amplitude is at a second predetermined level; and
registering the operating frequency that corresponds to the vibration as an avoid frequency and performing emergency control by stopping the compressor if the amplitude is at or greater than a third predetermined level.

18. The method of claim 17, wherein the first predetermined level is an amplitude of approximately 2 to 3 mm, the second predetermined level is an amplitude of approximately 3 to 5 mm, and the third predetermined level is an amplitude of 5 mm or greater.

19. The method of claim 14, further including deleting low-risk avoid frequencies and registering new avoid frequencies if a number of stored avoid frequencies is not less than a reference value.

20. The method of claim 14, further including:
detecting a change in season based on outdoor temperatures measured by the temperature sensor;
resetting existing avoid frequencies by deleting the existing avoid frequencies if the change in season is detected, and maintaining the existing avoid frequencies if the change in season is not detected.
